(19) United States
(12) Patent Application Publication
(10) Pub. No.: US 2021/0146738 A1
(43) Pub. Date: May 20, 2021

(54) WHEEL SUSPENSION FOR A MOTOR VEHICLE AND CORRESPONDING MOTOR VEHICLE

(71) Applicant: AUDI AG, Ingolstadt (DE)

(72) Inventors: Bastian BAHR, Donauwörth (DE); Ruben GOLDBERG, Ingolstadt (DE)

(73) Assignee: AUDI AG, Ingolstadt (DE)

(21) Appl. No.: 17/048,758

(22) PCT Filed: Mar. 28, 2019
(86) PCT No.: PCT/EP2019/057918

§ 371 Date: Oct. 19, 2020

(30) Foreign Application Priority Data
Apr. 25, 2018 (DE) 10 2018 206 402.4

(51) Int. Cl. B60G 3/20; B60G 7/00

(52) U.S. Cl. CPC B60G 3/20; B60G 7/008; B60G 7/001; B60G 2200/462; B60G 2300/50; B60G 2206/50; B60G 2204/143

(57) ABSTRACT

A wheel suspension for motor vehicle, having a wheel mount rotatably mounted around a steering axis for steering the motor vehicle, on which a wheel hub supporting a rim of a wheel is rotatably mounted or mountable by means of a wheel bearing around a wheel hub rotational axis and which has a bearing point for attaching a tie rod and having a first suspension arm arrangement and a second suspension arm arrangement, which engage on the wheel mount spaced apart from one another in the actual direction with respect to the steering axis for coupling the wheel mount to a vehicle body of the motor vehicle.

The invention relates to a wheel suspension for a motor vehicle, having a wheel mount rotatably mounted around a steering axis for steering the motor vehicle, on which a wheel hub supporting a rim of a wheel of the motor vehicle is rotatably mounted or mountable by means of a wheel bearing around a wheel hub rotational axis, and which has a bearing point for attaching a tie rod, and having a first suspension arm arrangement and a second suspension arm arrangement, which engage on the wheel mount spaced apart from one another in the axial direction with respect to the steering axis to couple the wheel mount to a vehicle body of the motor vehicle. The invention furthermore relates to a motor vehicle having a wheel suspension.

For example, the document DE 10 2015 221 217 A1 is known from the prior art. It relates to a wheel suspension of a steerable wheel of a two-track vehicle, having a wheel mount, which is pivotably guided around a steering rotational axis in relation to the vehicle body by means of wheel-guiding suspension arms and is pivotable around the steering rotational axis by displacement of a tie rod, which is operationally connected to the wheel mount via a steering arm thereof and is aligned at least approximately in the vehicle transverse direction.

In this case, the end section of the tie rod facing toward the wheel mount is connected via a joint, which permits a vertical compression and extension movement of the wheel mount in relation to the vehicle body, to an intermediate element having a rotational axis, which rotational axis spans a plane with the vehicle-body-side linkage point of the tie rod, which is inclined at an angle in the order of magnitude of ±45° in relation to the motor vehicle vertical axis.

In this case, the steering arm is fastened to the intermediate element pivotable around said rotational axis spaced apart from said joint and the rotational axis of the intermediate element is inclined in relation to the motor vehicle vertical axis in such a way that the linkage point of the steering arm on the intermediate element viewed in the vehicle transverse direction is closer to the vehicle center plane than the intersection of the rotational axis of the intermediate element with a straight line, which extends through the vehicle-body-side linkage point of the steering arm and the center of the joint between the tie rod and the intermediate element.

It is the object of the invention to propose a wheel suspension for a motor vehicle, which has advantages over known wheel suspensions, in particular a reduced negative toe angle, which is generated by the lateral force during cornering of the motor vehicle on the outer wheel.

This is achieved according to the invention by a wheel suspension for a motor vehicle having the features of claim 1. It is provided here that in the installed position of the wheel suspension, a kinematic point of a tie rod bearing used for attaching the tie rod to the bearing point is arranged, in the travel direction of the motor vehicle, in front of the steering axis and above a horizontal plane accommodating or intercepting the wheel hub rotational axis and arranged horizontally.

The wheel suspension is preferably a component of the motor vehicle. It is used to attach the wheel to the vehicle body of the motor vehicle. The wheel suspension is preferably provided and designed for the suspension, in particular the sprung suspension, of the wheel with respect to the vehicle body. The wheel is rotatably mounted on the wheel mount of the wheel suspension. For this purpose, the wheel is fastened or at least fastenable on the wheel hub, which is finally rotatably mounted on the wheel mount, for example by means of the wheel bearing. The wheel hub can be a component of the wheel bearing and/or can be integrated with it. For example, for this purpose the wheel hub is formed integrally and/or of the same material with an inner ring or an outer ring of the wheel bearing, while in contrast the respective other ring, i.e., either the outer ring or the inner ring, is fastened on the wheel mount.

The wheel mount has, for example, a wheel bearing receptacle, which can be formed as an opening, in particular as a peripherally-closed opening, in the wheel mount. The wheel bearing is arranged at least in regions in the wheel bearing receptacle. Moreover, wheel hub and/or a shaft coupled thereto in a rotationally-fixed manner engages at least in regions in the wheel bearing receptacle. Particularly preferably, the wheel hub and/or the shaft extend at least partially, in particular completely, in particular jointly, through the wheel bearing receptacle in the axial direction with respect to the rotational axis of the wheel hub.

The wheel bearing is preferably designed as a roller bearing and thus has the inner ring and the outer ring, between which roller bodies are provided for friction reduction. The inner ring is associated with the wheel hub, in particular connected to the wheel hub, for example it is integrally formed with it or fastened thereon, while in contrast the outer ring is associated with the wheel mount, in particular is connected to the wheel mount, for example is fastened thereon. In this case, the outer ring is preferably provided in the wheel bearing receptacle. In other words, the outer ring abuts with its outer circumferential surface an inner circumferential surface of the wheel mount delimiting the wheel bearing receptacle.

The wheel mount is preferably connected to the vehicle body via at least one chassis suspension rod. The chassis suspension rod thus engages, on the one hand, on the vehicle body and, on the other hand, on the wheel mount, in particular so it is pivotably movable in each case. The chassis suspension rod is provided, for example, in the form of a wishbone. A design as a trailing arm is also possible, however. In principle, the attachment of the wheel mount is carried out via the at least one chassis suspension arm. However, preferably multiple chassis suspension arms are provided for attaching the wheel mount to the vehicle body. In particular, the chassis suspension arm is provided in the form of a two-point suspension arm.

In principle, a sufficient number of chassis suspension arms is provided to ensure the wheel guiding. In addition, each wheel guide requires a vertical degree of freedom for compression and extension. In the wheel guide, one additionally distinguishes between a steered and a non-steered axle. While the non-steered wheel guide can be partially ensured via only one chassis suspension arm, for example, in the semi-trailing link axle, the steered wheel guide requires a further degree of freedom to be able to turn the wheels to the left and right. The steering axis can be skewed in the vehicle in this case. For the steered wheel guide, at least two chassis suspension arms are thus required, for example—in the simplest design—two wishbones, the centers of rotation of which, i.e. the wheel-mount-side attachment points of which or the intersections of the extended force action lines, form the spreading or steering axis in a resolved suspension arm composite.

Very generally, the steering axis is thus defined by the first suspension arm arrangement and the second suspension arm arrangement or the chassis suspension arms of the suspension arm arrangements. In particular, each of the suspension arm arrangements defines a point of the steering axis, so that for the two suspension arm arrangements, the steering axis corresponds to an imaginary straight line through the points defined by the suspension arm arrangements. Each of the chassis suspension arms of the suspension arm arrangements engages, on the one hand, on at least one first attachment point on the wheel mount and on a second attachment point on the vehicle body. The first attachment point or each of the first attachment points defines an imaginary straight line together with the second attachment point of the corresponding chassis suspension arm. The above-described point corresponds to the intersection of the imaginary straight line for the corresponding suspension arm arrangement.

The steering axis, also called the spreading axis, is usually located skewed in the motor vehicle, but it is essentially aligned in the direction of or parallel to the vertical axis, so that the respective wheel may be turned to the left and right. To thus depict the steering axis, the wheel-mount-side attachment points defining the steering axis have to be located in different vertical positions with respect to the vertical axis of the motor vehicle. These vertical positions are therefore also referred to as suspension rod planes.

In each case at least one chassis suspension arm is part of the first suspension arm arrangement and of the second suspension arm arrangement. In other words, both the first suspension arm arrangement and also the second suspension or arm arrangement each have at least one such chassis suspension arm. The two suspension arm arrangements are used for coupling or attaching the wheel mount to the vehicle body. For this purpose, they each engage, on the one hand, on the wheel mount and, on the other hand, can be coupled or are coupled to the vehicle body. The two suspension arm arrangements jointly form the suspension arm planes.

The wheel or at least the rim of the wheel is rotatably mounted on the wheel mount via the wheel hub. The rim is used as a carrier for a tire of the wheel, namely preferably for an air-filled tire. The wheel of the motor vehicle is steerable. For this purpose, the wheel mount is rotatably mounted around the steering axis, namely with respect to the vehicle body of the motor vehicle. The wheel mount is preferably attached via at least one shock absorber and/or at least one spring to the vehicle body for the damping or spring loading of the wheel with respect to the vehicle body. The shock absorber and/or the spring are provided in addition to the suspension arm arrangements. The vertical degree of freedom is implemented via the shock absorber and/or the spring.

The shock absorber and the spring can be components of a spring strut. To attach the shock absorber and/or the spring or the spring strut, the wheel mount preferably has a corresponding attachment point, for example a spring strut receptacle for the spring strut. To attach the spring strut to the wheel mount, the spring strut is arranged, for example in the spring strut receptacle of the wheel mount and fastened, preferably rigidly fastened on the wheel mount. The shock absorber and/or the spring or the spring strut can also be supported via one of the suspension arms against the vehicle body, however. This means that the shock absorber and/or the spring or the spring strut is linked via the suspension arm on the wheel mount and/or the vehicle body. This is preferably performed via only one single suspension arm, which can then be referred to as a support suspension arm.

The wheel suspension is provided, for example, as a double-wishbone wheel suspension. It has a first suspension arm plane and a second suspension arm plane, wherein the first suspension arm arrangement is provided in the first suspension arm plane and the second suspension arm arrangement is provided in the second suspension arm plane. The first suspension arm arrangement is preferably arranged in the installed position above the second suspension arm arrangement, so that the first suspension arm arrangement can also be referred to as the upper suspension arm arrangement and the second suspension arm arrangement can also be referred to as the lower suspension arm arrangement. For example, the double-wishbone wheel suspension has two wishbones. However, preferably both suspension arm arrangements each have two two-point suspension arms, which are angled or V-shaped in relation to one another and have a virtual intersection which finally also defines the steering axis. The steering axis is provided in this case as the virtual intersections of the imaginary straight line connecting the suspension arm arrangements. This is also referred to in this case as a resolved suspension arm plane or a suspension arm composite.

The wheel suspension according to the invention is supposed to have a reduction of the negative toe angle generated on the outer wheel during cornering of the motor vehicle due to the lateral force. This results in a reduction of the dynamic amplification of a yaw rate of the motor vehicle or a steering wheel angle, so that overall the driving stability of the motor vehicle is improved. For this purpose, it is provided that—in the installed position of the wheel suspension—the kinematic point of the tie rod bearing is provided, in the travel direction of the motor vehicle, in front of the steering axis and above the horizontal plane.

The installation position is to be understood as an arrangement of the wheel suspension on or in the motor vehicle for the intended use of the motor vehicle. In other words, the wheel suspension is provided in the installation position in such a way on or in the motor vehicle that driving operation of the motor vehicle is possible. The installation position can be provided after an actual installation of the wheel suspension on or in the motor vehicle. However, the installation position can also describe an arrangement of the wheel suspension in such a way that it is provided similarly to an actually installed state. To arrange the wheel suspension in the installation position, it is thus not necessary to actually install the wheel suspension on or in the motor vehicle, although this can be provided, of course.

The tie rod is rotatably mounted with respect to the wheel mount via the tie rod bearing, namely on the bearing point of the wheel mount. The bearing point is provided, for example, on a steering arm of the wheel mount, which is formed as a projection that originates from a main body of the wheel mount. The wheel bearing receptacle is preferably formed in the main body. It can be provided that the tie rod bearing is integrated into the tie rod. However, it can also be provided separately from it. The kinematic point describes a center of rotation of the tie rod bearing. The tie rod bearing typically permits both a rotational movement of the tie rod around a tie rod rotational axis and also a tilting movement of the tie rod with respect to the wheel mount. The rotational movement and the tilting movement take place around the kinematic point, it thus represents a rotation point or center of rotation of the tie rod bearing. The kinematic point is preferably located on the rotational axis of the tie rod bearing. The tie rod bearing is preferably provided as a ball joint or ball stud joint.

The tie rod bearing is arranged and designed in such a way that the kinematic point has a special arrangement. It is thus to be located, in the travel direction of the motor vehicle, in front of the steering axis and above the horizontal plane. The horizontal plane is to be understood as a horizontal plane which, for example—with an assumed wheel camber of zero—completely accommodates the wheel hub rotational axis or—with a wheel camber different from zero—is intersected by it at least in one intersection. The horizontal plane is preferably provided, after installation of the wheel suspension on or in the motor vehicle, in parallel to an underlying surface on which the motor vehicle is arranged. The underlying surface can be provided, for example, in the form of a roadway or a road. The horizontal plane is thus spanned after the installation of the wheel suspension by a longitudinal axis and a transverse axis of the motor vehicle and is perpendicular to a vertical axis of the motor vehicle.

For example, an imaginary plane perpendicular to the inner circumferential surface of the wheel mount delimiting the wheel bearing receptacle is provided, which intersects the wheel hub rotational axis in an intersection. The imaginary plane is preferably located centrally in the wheel bearing receptacle in the axial direction with respect to a longitudinal center axis of the wheel bearing receptacle, and thus represents a center point plane of the wheel bearing receptacle. The horizontal plane is now located in parallel to the underlying surface and accommodates the intersection of the wheel hub rotational axis and the imaginary plane.

The arrangement of the kinematic point in front of the steering axis is to be understood, for example, to mean that the kinematic point is arranged in a plane accommodating the kinematic point and perpendicular to the transverse axis on a side facing away from a rear of the motor vehicle and a side of the steering axis facing toward a front of the motor vehicle or a bow of the motor vehicle. In other words, the kinematic point is arranged in front of the steering axis in the travel direction.

The special design of the wheel suspension enables a significant reduction of the negative toe angle in comparison to known wheel suspensions. Such a wheel suspension is particularly preferably used in an electrically driven motor vehicle, in particular in an exclusively electrically driven motor vehicle. In such a motor vehicle, a drive device of the motor vehicle, which can provide a torque directed toward driving the motor vehicle, occupies comparatively little installation space, so that there is greater freedom with respect to the arrangement of the tie rod bearing and therefore of the kinematic point.

For example, it is provided that the bearing point or a steering arm of the wheel mount having the bearing point is arranged at least in regions or completely below the horizontal plane. In other words, it can be provided that the horizontal plane intersects the bearing point or the steering arm or terminates flush with it. However, it can also be provided that the bearing point or the steering arm is provided below the horizontal plane and spaced apart from it. In this case, the tie rod bearing is arranged with respect to the bearing point or the steering arm in such a way that the kinematic point of the arrangement of the bearing point or of the steering arm is nonetheless provided above the horizontal plane. Due to the arrangement of the bearing point or the steering arm at least in regions or completely below the horizontal plane, structural space is provided, which can be used, for example, for arranging the drive device of the motor vehicle.

A further design of the invention provides that the first suspension arrangement and/or the second suspension arm arrangement each have a resolved suspension arm composite and/or at least one individual suspension arm. This means each of the suspension arm arrangements either has a suspension arm composite or multiple individual suspension arms. However, it can also be provided that at least one of the suspension arm arrangements or both suspension arm arrangements have both a suspension arm composite and also at least one individual suspension arm. The individual suspension arm can also be referred to as a two-point suspension arm. The use of the resolved suspension arm composite and/or the at least one individual suspension arm has the advantage that the steering axis can be selected more freely than, for example, with a wishbone.

The distance of the steering axis to the kinematic point determines the lever action and thus the forces acting on the steering.

In the scope of a further embodiment of the invention, it can be provided that the tie rod bearing directly adjoins the horizontal plane or is arranged above the horizontal plane. In each case, the tie rod bearing is provided completely above the horizontal plane. In the first case, it directly adjoins it, in the latter case, it is arranged at a distance to the horizontal plane. In each case, the arrangement of the kinematic point above the horizontal plane is ensured, so that the advantages according to the invention can be implemented.

A further embodiment of the invention provides that the tie rod bearing is used for the rotatable mounting of the tie rod around a tie rod rotational axis, wherein the kinematic point is provided in the direction of the tie rod rotational axis within the tie rod bearing. Such a design was already noted. For example, the tie rod bearing has a bearing body, which is fastened on the tie rod or is formed integrally with it, and a bearing housing, in which the bearing body is rotatably arranged. The bearing body is provided, for example, in the form of a sphere or at least a partial sphere.

The bearing housing is designed in such a way that the bearing body cannot move out of it during proper use. The bearing housing is provided and designed for fastening on the wheel mount at the bearing point. The tie rod rotational axis preferably describes, for example a main rotational direction of the tie rod bearing. For example, the tie rod rotational axis is perpendicular to the horizontal plane. However, an angled arrangement in relation to the horizontal plane can also be provided, so that the tie rod rotational axis encloses an angle with the horizontal plane which is greater than 0° and less than 180°. To permit both rotation and also tilting of the tie rod with respect to the wheel mount by means of the tie rod bearing, the kinematic point, around which both the rotation and also the tilting take place, is inside the tie rod bearing, preferably centrally in the bearing body. Such a design enables a reliable mounting of the tie rod with respect to the wheel mount having multiple degrees of freedom.

In the scope of a further embodiment of the invention, it can be provided that the kinematic point is arranged between the horizontal plane and a plane parallel to the horizontal plane, which accommodates a vertex of a wheel bearing receptacle formed in the wheel mount to accommodate the wheel bearing. As already explained, the wheel bearing receptacle, in which the wheel bearing is arranged or is at least arrangeable, is formed in the wheel mount. The vertex is to be understood as the point of the wheel bearing receptacle spaced apart farthest from the horizontal plane, which is provided above the horizontal plane. In other words, the vertex is arranged on a side of the horizontal plane facing away from the underlying surface. The arrangement of the kinematic point between the horizontal plane and the plane parallel to it has the advantage that a particularly compact design of the wheel suspension is achieved.

One refinement of the invention provides that the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane. The rim is to be understood as a rim provided for the intended use of the motor vehicle. It has a rim jacket, which is provided and designed to support a tire of the wheel. The tire preferably abuts a rim bed of the rim or the rim jacket. In other words, the tire is supported in the radial direction with respect to the wheel hub rotational axis from the outside on the rim jacket.

The tangential plane now tangentially abuts on the rim jacket, preferably centrally or alternatively peripherally viewed in the axial direction with respect to the wheel hub rotational axis. In any case, however, the tangential plane is provided above the horizontal plane. The tangential plane is either perpendicular to the steering axis or is arranged in parallel to the horizontal plane. It can also be provided that both definitions result in identical tangential planes, so that the steering axis thus intersects with a point of the rim jacket farthest away from the horizontal plane. Independently of the definition of the tangential plane, the kinematic point is to be arranged between the horizontal plane and the tangential plane. This enables simple and effective matching or adaptation of the negative toe angle.

A further embodiment of the invention provides that the first suspension arm arrangement engages on the wheel mount on the side of the tangential plane facing away from the horizontal plane. The first suspension arm arrangement or the at least one suspension arm of the first suspension arm arrangement preferably engages directly on the wheel mount. The first suspension arm arrangement or the suspension arm is rotatably or pivotably mounted on the wheel mount by means of a bearing. The first suspension arm arrangement engages outside the rim jacket on the wheel mount and accordingly on the side of the tangential plane facing away from the horizontal plane. In this way, a particularly good wheel guide is achieved by means of the wheel suspension.

Additionally or alternatively, a further design of the invention can provide that the second suspension arm arrangement engages on the wheel mount on the side of the horizontal plane facing away from the kinematic point. In other words, the second suspension arm arrangement engages on the wheel mount on the side of the horizontal plane facing away from the tangential plane. Similarly to the first suspension arm arrangement, the second suspension arm arrangement preferably engages directly on the wheel mount and is rotatably or pivotably mounted thereon in this way. The engagement of the second suspension arm arrangement on the wheel mount takes place inside the rim jacket, so that, on the one hand, there is a sufficient ground clearance, i.e., a sufficient distance between the second suspension arm arrangement and the underlying surface and, on the other hand, a reliable wheel guide is provided.

A further embodiment of the invention provides that the first suspension arm arrangement forms a first suspension arm plane and the second suspension arm arrangement forms a second suspension arm plane, wherein in a top view of the rim jacket in the axial direction with respect to the wheel hub rotational axis, the first suspension arm plane and the second suspension arm plane are arranged inside the rim jacket, or one of the suspension arm planes is arranged outside the rim jacket and the respective other one is arranged inside the rim jacket, in particular an upper one of the suspension arm planes in the installed position is provided outside the rim jacket. Instead of the term rim jacket, the term wheel disk can also be used at this point. The respective suspension arm plane is preferably located in a top view completely inside or outside the rim jacket, but at least in the largest part. A particularly effective reduction of the negative toe angle is achieved using such a design.

Finally, it can be provided in the scope of a further preferred design of the invention that a further tangential plane, which is different from the tangential plane, tangentially abuts the rim jacket below the horizontal plane, wherein the further tangential plane is perpendicular to the steering axis or is arranged in parallel to the horizontal plane, wherein the second suspension arm arrangement engages on the wheel mount between the horizontal plane and the further tangential plane. The further tangential plane is thus defined similarly to the tangential plane, but it is located below the horizontal plane and thus on the side of the horizontal plane facing away from the tangential plane. The second suspension arm arrangement now engages between the horizontal plane and the further tangential plane on the wheel mount. A sufficient ground clearance for the second suspension arm arrangement is achieved in this way.

The invention furthermore relates to a motor vehicle having a wheel suspension, in particular a wheel suspension according to the statements in the scope of this description, wherein the wheel suspension has a wheel mount rotatably mounted around a steering axis for steering the motor vehicle, on which a wheel hub supporting a rim of a wheel of the motor vehicle is rotatably mounted around a wheel hub rotational axis by means of a wheel bearing and which has a bearing point for attachment of a tie rod, and has a first bearing arrangement and a second bearing arrangement, which engage on the wheel mount spaced apart from one another in the axial direction with respect to the steering axis for coupling the wheel mount to a vehicle body of the motor vehicle.

It is provided here that in the installed position of the wheel suspension, a kinematic point of a tie rod bearing used for attaching the tie rod to the bearing point is arranged, in the travel direction of the motor vehicle, in front of the steering axis and above a horizontal plane accommodating or intersecting the wheel hub axis and arranged horizontally.

The advantages of such a design of the wheel suspension and of the motor vehicle were already noted. Both the motor vehicle and also the wheel suspension, which forms a component of the motor vehicle, can be refined according to the statements in the scope of this description, so that reference is thus made thereto.

The invention is explained in greater detail hereinafter on the basis of the exemplary embodiments illustrated in the drawings, without the invention being restricted. In the figures

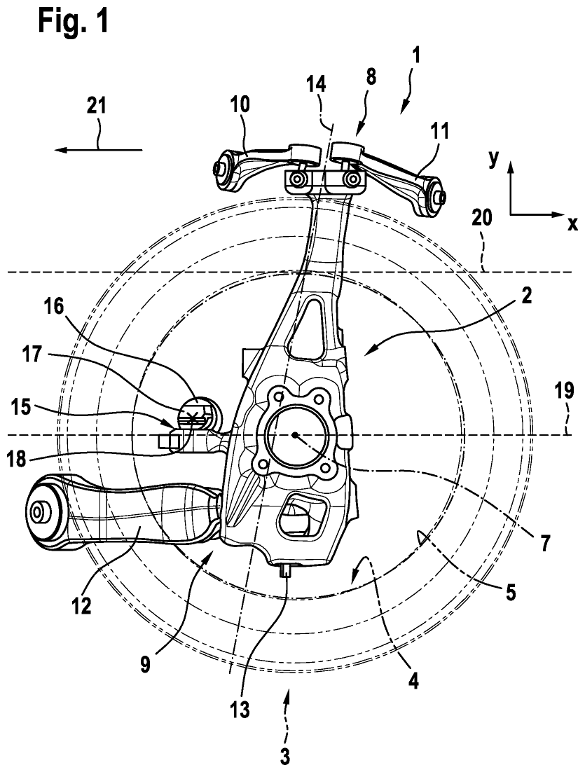

FIG. 1 shows a schematic illustration of a wheel suspension for a motor vehicle, and

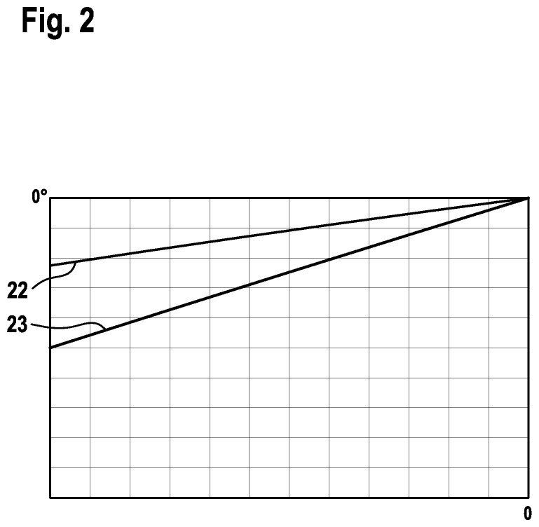

FIG. 2 shows a diagram in which a toe angle is plotted over a lateral force.

FIG. 1 shows a schematic illustration of a wheel suspension 1 for a motor vehicle in the installed position. The wheel suspension 1 is thus arranged in a motor-vehicle-fixed coordinate system, wherein the direction x describes a longitudinal axis of the motor vehicle and the direction y describes a vertical axis of the motor vehicle. A transverse axis is perpendicular to these two axes, i.e., to both the longitudinal axis and also the vertical axis.

The wheel suspension 1 has a wheel mount 2, by means of which a wheel 3 of the motor vehicle is rotatably mounted, specifically with respect to a vehicle body (not shown here) of the motor vehicle. The wheel 3 has a rim 4, which has a rim jacket 5 and rim walls, which originate from the rim jacket 5 and extend outward in the radial direction with respect to a rotational axis 7 of the wheel 3. The rim 4 is fastened on a wheel hub (not shown in greater detail here), which is in turn rotatably mounted with respect to the wheel mount 2 by means of a wheel bearing (also not shown). The rotational axis 7 describes in this case the rotational axis of the wheel hub or the wheel bearing, so that it can also be referred to as the wheel hub rotational axis.

The wheel mount 2 is linked or is linkable by means of a first suspension arm arrangement 8 and a second suspension arm arrangement 9 on a vehicle body of the motor vehicle. The first suspension arm arrangement 8 has suspension arms 10 and 11 in the illustrated exemplary embodiment, the second suspension arm arrangement 9 has suspension arms 12 and 13. The suspension arms 10, 11, 12, and 13 are each designed as two-point suspension arms and are rotatably or pivotably mounted on the wheel mount 2. The two suspension arm arrangements 8 and 9 engage spaced apart from one another in the axial direction with respect to a steering axis 14 on the wheel mount 2.

Two suspension arm planes are thus formed, wherein a first suspension arm plane is represented by the first suspension arm arrangement 8 and a second suspension arm plane is represented by the second suspension arm arrangement 9. The wheel mount 2 is rotatable with respect to the vehicle body around the steering axis 14, i.e., is rotatably mounted or can be mounted on the vehicle body around the steering axis 14. The wheel mount 2 is correspondingly rotatable around the steering axis 14 for steering the motor vehicle. In other words, the wheel 3 is a steerable wheel. The steering axis 14 is defined by the first suspension arm arrangement 8 and the second suspension arm arrangement 9, wherein each of the suspension arm arrangements 8 and 9 defines an instantaneous center of rotation and the steering axis 14 is provided as the imaginary straight line extending through the instantaneous centers of rotation.

The wheel mount 2 has a bearing point 15 for attaching a tie rod 16 to the wheel mount 2. A pivot movement of the wheel mount 2 around the steering axis 14, which is used for steering the motor vehicle, can be applied to the wheel mount 2 via the tie rod 16. A tie rod bearing 17, via which the tie rod 16 is attached to the wheel mount 2, is provided for mounting the tie rod 16 on the wheel mount 2 or the bearing point 15. The tie rod bearing 17 has a kinematic point 18, around which the tie rod 16 is pivotable with respect to the wheel mount 2.

In the installed position of the wheel suspension 1 shown here, the kinematic point 18 is located in front of the steering axis 14 in the travel direction indicated by an arrow 21. Moreover, it is arranged above a horizontal plane 19, which accommodates the rotational axis 7 and is arranged horizontally, namely with respect to an underlying surface (not shown here), on which the motor vehicle is located. The steering axis 14 is preferably angled with respect to the horizontal plane 19, and thus encloses an angle with it which is greater than 0° and less than 180°. A tangential plane 20, which tangentially abuts the rim jacket 5, is provided in parallel to the horizontal plane 19.

It can be seen clearly that the first suspension arm arrangement 8 is arranged on the side of the tangential plane 20 facing away from the horizontal plane 19 and also engages there on the wheel mount 2. The second suspension arm arrangement 9, in contrast, is provided on the side of the horizontal plane 19 facing away from the tangential plane 20 and also engages there on the wheel mount 2. In other words, the second suspension arm arrangement 9 is provided below the horizontal plane 19. Moreover, the kinematic point 18 is arranged above the horizontal plane 19, in particular between the horizontal plane 19 and the tangential plane 20.

In addition to the tangential plane 20, a further tangential plane (not shown here) can be defined, which is provided below the horizontal plane 19, i.e., on the side of the horizontal plane 19 facing away from the tangential plane 20, and tangentially abuts the rim jacket 5 there. The further tangential plane is also preferably arranged in parallel to the horizontal plane 19. In other words, the further tangential plane results by way of mirroring of the tangential plane 20 at the horizontal plane 19. The second suspension arm arrangement 9 is preferably arranged at least partially or even completely between the horizontal plane 19 and the further tangential plane.

Using the above-described design of the wheel suspension 1, in which the kinematic point 18 or a center of rotation of the tie rod bearing 17 is located above the horizontal plane 19 and in front of the steering axis 14 in the travel direction, a negative toe angle, which results during cornering of the motor vehicle due to the lateral force on the outside wheel, can be significantly reduced. This in turn results in a reduction of the dynamic amplification of the yaw rate of the motor vehicle or of a steering wheel angle. The driving comfort and the driving stability of the motor vehicle are significantly improved in this way.

FIG. 2 shows a diagram in which a toe angle is plotted over the lateral force for an outside wheel during cornering of the motor vehicle. An absolute value or amount of the lateral force becomes greater viewed from right to left, and absolute value of the toe angle from top to bottom. A curve 22 shows the toe angle for the described wheel suspension 1, a curve 22, in contrast, for a conventional wheel suspension. It is clearly apparent that the absolute value of the toe angle rises more slowly with increasing lateral force for the curve 22 than for the curve 23.

1-10. (canceled)

11. A wheel suspension for motor vehicle, comprising:
a wheel mount rotatably mounted around a steering axis for steering the motor vehicle, on which a wheel hub supporting a rim of a wheel of the motor vehicle is rotatably mounted or mountable by means of a wheel bearing around a wheel hub rotational axis and which has a bearing point for attaching a tie rod and having a first suspension arm arrangement and a second suspension arm arrangement, which engage on the wheel mount spaced apart from one another in the axial direction with respect to the steering axis for coupling the wheel mount to a vehicle body of the motor vehicle, wherein in the installed position of the wheel suspension, a kinematic point of a tie rod bearing, used for attaching the tie rod to the bearing point, is arranged in the travel direction of the motor vehicle in front of the steering axis and above a horizontal plane, which accommodates or intersects the wheel hub rotational axis and is arranged horizontally.

12. The wheel suspension according to claim 11, wherein the first suspension arm arrangement and/or the second suspension arm arrangement each have a resolved suspension arm composite and/or at least one individual suspension arm.

13. The wheel suspension according to claim 11, wherein the tie rod bearing directly adjoins the horizontal plane or is arranged above the horizontal plane.

14. The wheel suspension according to claim 11, wherein the tie rod bearing is used for rotatably mounting the tie rod around a tie rod rotational axis, wherein the kinematic point is provided in the direction of the tie rod rotational axis within the tie rod bearing.

15. The wheel suspension according to claim 11, wherein the kinematic point is arranged between the horizontal plane and a plane parallel to the horizontal plane, which accommodates a vertex of a wheel bearing receptacle formed in the wheel mount to accommodate the wheel bearing.

16. The wheel bearing arrangement according to claim 11, wherein the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane.

17. The wheel suspension according to claim 11, wherein the first suspension arm arrangement engages on the wheel mount on the side of the tangential plane facing away from the horizontal plane, and/or in that the second suspension arm arrangement engages on the wheel mount on the side of the horizontal plane facing away from the kinematic point.

18. The wheel mount arrangement according to claim 11, wherein the first suspension arm arrangement forms a first suspension arm plane and the second suspension arm arrangement forms a second suspension arm plane, wherein, in a top view of the rim jacket, in the axial direction with respect to the wheel hub rotational axis
the first suspension arm plane and the second suspension arm plane are arranged inside the rim jacket, or
one of the suspension arm planes is arranged outside the rim jacket and the respective other one is arranged inside the rim jacket, in particular an upper of the suspension arm planes in the installed position is provided outside the rim jacket.

19. The wheel suspension according to claim 11, wherein a further tangential plane different from the tangential plane tangentially abuts the rim jacket below the horizontal plane, wherein the further tangential plane is perpendicular to the steering axis or is arranged in parallel to the horizontal plane, wherein the second suspension arm arrangement engages on the wheel mount between the horizontal plane and the further tangential plane.

20. A motor vehicle having a wheel suspension, in particular a wheel suspension as claimed in claim 11, wherein the wheel suspension has a wheel mount rotatably mounted around a steering axis for steering the motor vehicle, on which a wheel hub supporting a rim of a wheel of the motor vehicle is rotatably mounted around a wheel hub rotational axis and which has a bearing point for attaching a tie rod, and has a first suspension arm arrangement and a second suspension arm arrangement, which engage spaced apart from one another in the axial direction with respect to the steering axis on the wheel mount for coupling the wheel mount to a vehicle body of the motor vehicle, wherein in the installed position of the wheel suspension, a kinematic point of a tie rod bearing used for attaching the tie rod to the bearing point is arranged in the travel direction of the motor vehicle in front of the steering axis and above a horizontal plane, which accommodates or intersects the wheel hub rotational axis and is arranged horizontally.

21. The wheel suspension according to claim 12, wherein the tie rod bearing directly adjoins the horizontal plane or is arranged above the horizontal plane.

22. The wheel suspension according to claim 12, wherein the tie rod bearing is used for rotatably mounting the tie rod around a tie rod rotational axis, wherein the kinematic point is provided in the direction of the tie rod rotational axis within the tie rod bearing.

23. The wheel suspension according to claim 13, wherein the tie rod bearing is used for rotatably mounting the tie rod around a tie rod rotational axis, wherein the kinematic point is provided in the direction of the tie rod rotational axis within the tie rod bearing.

24. The wheel suspension according to claim 12, wherein the kinematic point is arranged between the horizontal plane and a plane parallel to the horizontal plane, which accommodates a vertex of a wheel bearing receptacle formed in the wheel mount to accommodate the wheel bearing.

25. The wheel suspension according to claim 13, wherein the kinematic point is arranged between the horizontal plane and a plane parallel to the horizontal plane, which accommodates a vertex of a wheel bearing receptacle formed in the wheel mount to accommodate the wheel bearing.

26. The wheel suspension according to claim 14, wherein the kinematic point is arranged between the horizontal plane and a plane parallel to the horizontal plane, which accommodates a vertex of a wheel bearing receptacle formed in the wheel mount to accommodate the wheel bearing.

27. The wheel bearing arrangement according to claim 12, wherein the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane.

28. The wheel bearing arrangement according to claim 13, wherein the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane.

29. The wheel bearing arrangement according to claim 14, wherein the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane.

30. The wheel bearing arrangement according to claim 15, wherein the rim has a rim jacket and a tangential plane above the horizontal plane tangentially abuts the rim jacket, wherein the tangential plane is perpendicular to the steering axis or is arranged in parallel to the horizontal plane, and wherein the kinematic point is arranged between the horizontal plane and the tangential plane.
